(19) United States
(12) Patent Application Publication
(10) Pub. No.: US 2015/0263431 A1
(43) Pub. Date: Sep. 17, 2015

(54) ANTENNA FOR MOBILE-COMMUNICATION BASE STATION

(71) Applicant: KMW Inc., Hwaseong (KR)

(72) Inventors: Young-Chan Moon, Hwaseong (KR); Oh-Seog Choi, Hwaseong (KR); Seung-Mok Han, Hwaseong (KR); Jae-Hwan Lim, Hwaseong (KR)

(73) Assignee: KMW Inc.

(21) Appl. No.: 14/723,217

(22) Filed: May 27, 2015

Related U.S. Application Data
(63) Continuation of application No. PCT/KR2013/010990, filed on Nov. 29, 2013.

(30) Foreign Application Priority Data
Nov. 30, 2012 (KR) 10-2012-0137888

(51) Int. Cl. H01Q 13/10; H01Q 9/04; H01Q 1/24

(52) U.S. Cl. CPC H01Q 13/106; H01Q 1/241; H01Q 9/0414

(57) ABSTRACT

The present invention relates to an antenna for a mobile-communication base station and includes a reflective plate, and a first radiant element having a first frequency band formed on the reflective plate, wherein the first radiant element includes: a slot structure that is formed as a letter “X” hole directly in the entire reflective plate and generates a transmission signal having X-shaped dual polarizations that are orthogonal to each other, and a metallic patch plate that is installed on the top of the slot structure so as to be insulated from the reflective plate.

### CROSS REFERENCE TO RELATED APPLICATIONS

This application is a continuation of International Application No. PCT/KR2013/010990 filed on Nov. 29, 2013, which claims priority to Korean Applications No. 10-2012-0137888 filed on Nov. 30, 2012, which applications are incorporated herein by reference.

### TECHNICAL FIELD

The present disclosure relates to an antenna for a mobile communication base station used in a mobile communication system, and more particularly, to an antenna for a mobile communication base station, which is appropriate for use in an antenna having a dual-band and dual-polarization structure.

### BACKGROUND ART

An antenna for a base station, as well as a relay device, used in a mobile communication system may have various forms and structures, and typically has a structure in which multiple radiant elements are properly disposed on at least one longitudinally upright reflective plates.

To meet demands for miniaturization and lightweight of base station antennas, various studies have been recently carried out, among which a study of a dual-band and dual-polarization antenna has developed an antenna having a structure in which a second radiant element of, for example, an Advanced Wireless Service (AWS) band or a high-frequency band of 2 GHz is stacked on a first radiant element of, for example, a low-frequency band of 700/800 MHz.

This type of antenna may have first and second radiant elements having a stacked structure in which the second radiant element of, for example, a patch type or a dipole type is installed on the first radiant element of, for example, the patch type, and a plurality of first and second radiant elements having the stacked structure may be disposed on a reflective plate at intervals that satisfy radiant element arrangement of a first frequency band.

Between the plurality of installed first and second radiant elements having the stacked structure, the second radiant element is additionally installed on the reflective plate to satisfy radiant arrangement of a second frequency band. Due to such arrangement, an antenna gain may be obtained while satisfying miniaturization as a whole.

FIG. 1 is a plane view of an example of a conventional dual-band and dual-polarization antenna for a mobile communication base station, and FIG. 2 is a perspective cross-sectional view cut along a portion A-A′ of FIG. 1. As to an antenna having a structure in which a second radiant element is stacked on a first radiant element in FIGS. 1 and 2, patch-type first radiant elements 11 and 12 of a first frequency band (for example, a band of 700/800 MHz) are disposed at predetermined intervals on a top surface of a reflective plate 1. Dipole-type second radiant elements 21, 22, 23, and 24 of a second frequency band (for example, an AWS band) are stacked on the first radiant elements 11 and 12, or are directly installed on the top surface of the reflective plate 1 between the first radiant elements 11 and 12.

The first radiant elements 11 and 12 include upper patch plates 11-2 and 12-2 and lower patch plates 11-1 and 12-1, respectively. The lower patch plates 11-1 and 12-1 are connected, through a feeding cable 112 passing through the reflective plate 1, with a circuit board 111 in which a feeding conductive pattern attached to a rear surface of the reflective plate 1 is formed. The second radiant elements 21 and 22 stacked on the first radiant elements 11 and 12 are connected with a feeding network through a feeding cable 212 that passes through the reflective plate 1 and the upper and lower patch plates 11-1 and 11-2 of the installed first radiant elements 11 and 12.

FIG. 3 illustrates a feeding structure of the first radiant elements illustrated in FIG. 1, in which (a) of FIG. 3 is a plane view and (b) of FIG. 3 is a rear view. In FIG. 3, for convenience, the lower patch plate 11-1 of one of the first radiant elements and the circuit board 111 having the feeding conductive pattern formed therein are illustrated, and other elements are omitted. Referring to FIGS. 1 through 3, the lower patch plate 11-1 of the first radiant element 11 is connected with the circuit board 111 attached on the rear surface of the reflective plate 1 through the feeding cable 112 passing through the reflective plate 1. That is, the feeding conductive pattern of the first radiant element is formed on the circuit board 111 by using a printing scheme, and feeding points a-d in the printed circuit board 111 and feeding points a-d of the lower patch plate 11-1 are connected through the feeding cable 112.

For example, the feeding conductive pattern is formed in the circuit board 111 in such a way that a transmission signal is phase-delayed by 180° with respect to a feeding point a, at a feeding point c which is diagonal to the feeding point a, and likewise, a transmission signal is phase-delayed by 180° with respect to a feeding point b, at a feeding point d which is diagonal to the feeding point b. Thus, on the lower patch plate 11-1 of the first radiant element, dual polarizations occur which are orthogonal to each other at the feeding points a and c and the feeding points b and d. The upper patch plate 11-2 of the first radiant element is installed for optimization of radiant characteristics, and is installed using a support made of, for example, a plastic material so as to be insulated from the lower path plate 11-1.

An example of a base station antenna structured as described above is disclosed in a Korean Patent Application No. 10-2009-0110696 filed by the present applicant (a title: Method for Installing Radiant Elements Disposed on Different Planes and Antenna Using the Method, inventors: Young-Chan Moon et al., and a filing date: Nov. 17, 2009).

In such arrangement of the first and second radiant elements, the second radiant element installed by being staked on the first radiant element and second radiant elements installed independently are installed on different planes, such that if a signal of the second frequency band is emitted, a phase difference occurs. For example, a height difference between the second radiant element installed by being stacked on the first radiant element and the second radiant elements installed independently may be about 50 mm. Due to a phase delay generated between the second radiant elements having such a height difference, a horizontal beam-width reduction increases in antenna down-tilt.

Moreover, the second radiant element installed by being stacked on the first radiant element uses the upper patch plate of the patch-type first radiant element as a ground terminal. The upper patch plate of the first radiant element is designed to have a smaller size than the lower patch plate so as to satisfy radiation characteristics, making it difficult to meet a condition for a ground area required in the dipole-type second radiation element. As a result, due to an insufficient ground area, pattern characteristics of a radio frequency degrade in the second radiant element.

### SUMMARY

The present disclosure provides an antenna for a mobile communication base station, in which an overall antenna size may be reduced, and particularly, in a dual-band antenna having a second radiant element of a second frequency band installed stacked on a first radiant element of a first frequency band and a second radiant element of the second frequency band installed independently, a height difference between the second radiant elements may be reduced, a ground area required in the second radiant element installed stacked on the first radiant element may be sufficiently secured, and radiation characteristics may be improved.

In accordance with an aspect of the present disclosure, there is provided an antenna for a mobile communication base station, the antenna including a reflective plate and a first radiant element of a first frequency band, which is formed on the reflective plate, in which the first radiant element includes a slot structure which is directly formed in the reflective plate in the form of an overall X-shaped hole to generate a transmission signal having X-shaped dual polarizations that are orthogonal to each other and a patch plate formed of a metallic material on a top surface of the slot structure in such a way to be insulated from the reflective plate.

### BRIEF DESCRIPTION OF THE DRAWINGS

FIG. 1 is a plane view of an example of a conventional dual-band and dual-polarization antenna for a mobile communication base station;

FIG. 2 is a perspective cross-sectional view cut along a portion A-A′ of FIG. 1;

FIGS. 3A and 3B show a plane view and a rear view illustrating a feeding structure of first radiant elements illustrated in FIG. 1;

FIG. 4 is a plane view of a dual-band and dual-polarization antenna for a mobile communication base station according to an embodiment of the present disclosure;

FIG. 5 is a perspective cross-sectional view cut along a portion A-A′ of FIG. 4;

FIGS. 6A and 6B show a plane view and a rear view illustrating a feeding structure of a first radiant element illustrated in FIG. 4; and

FIG. 7 is a perspective view of FIG. 6.

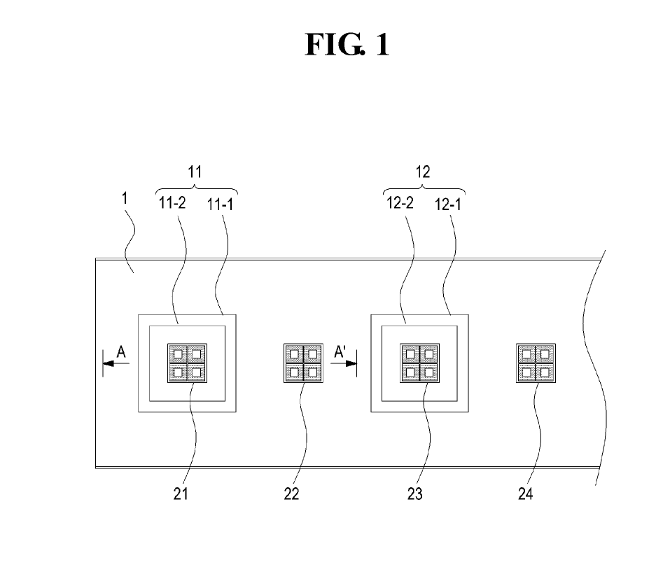

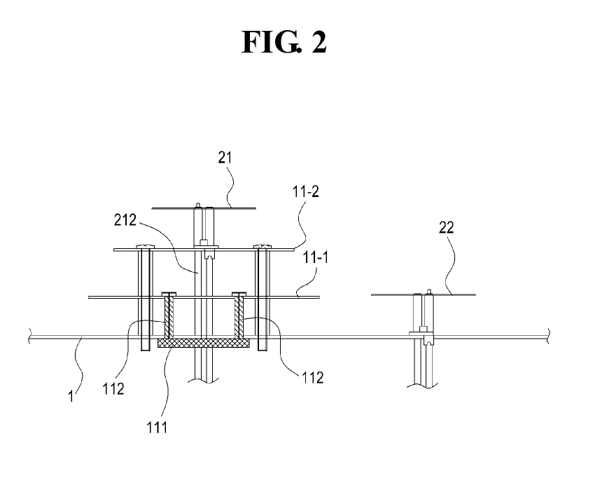

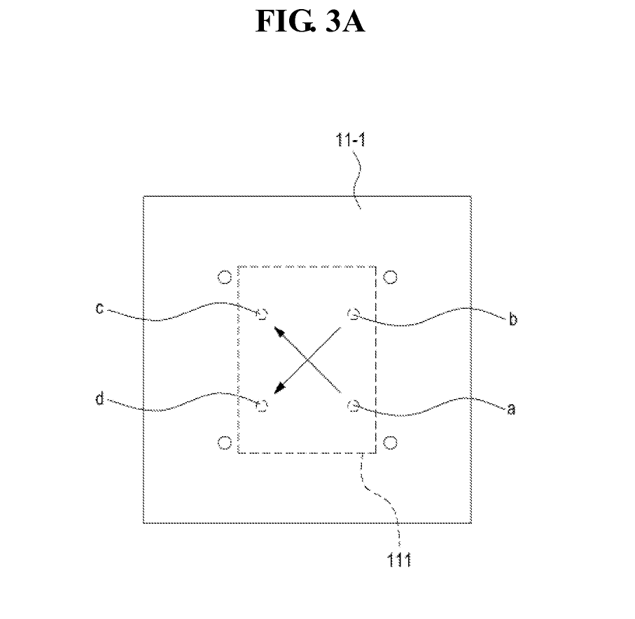

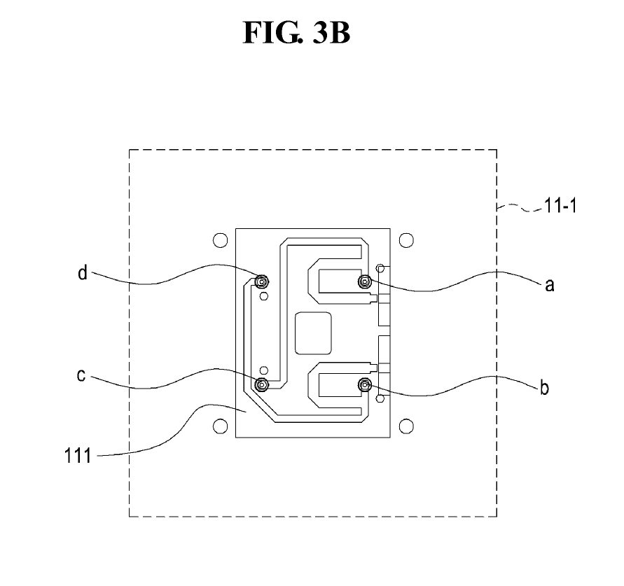

### DETAILED DESCRIPTION

Hereinafter, exemplary embodiments of the present disclosure will be described with reference to the accompanying drawings in detail. In the following description, specific matters such as detailed components have been described and they are provided to help overall understanding of the present disclosure, and it would be obvious to those of ordinary skill in the art that various changes and modifications can be made to the present disclosure.

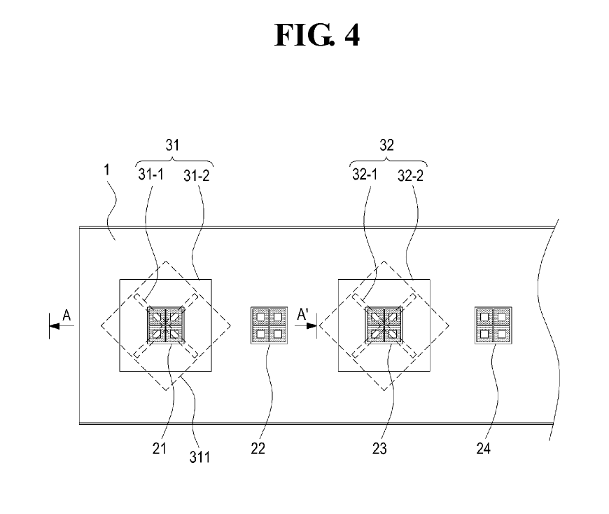

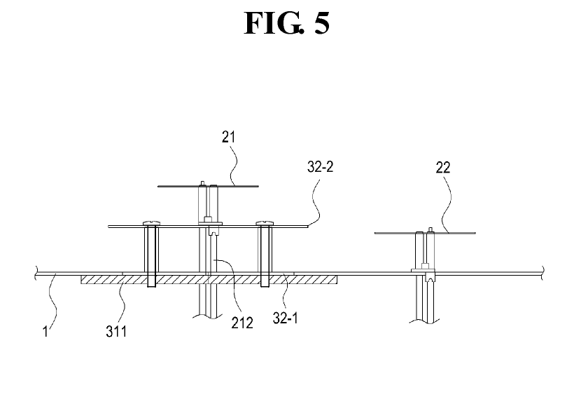

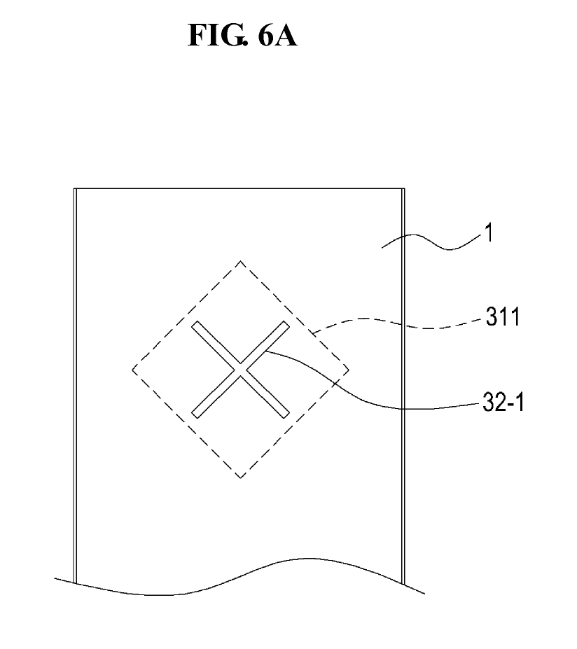

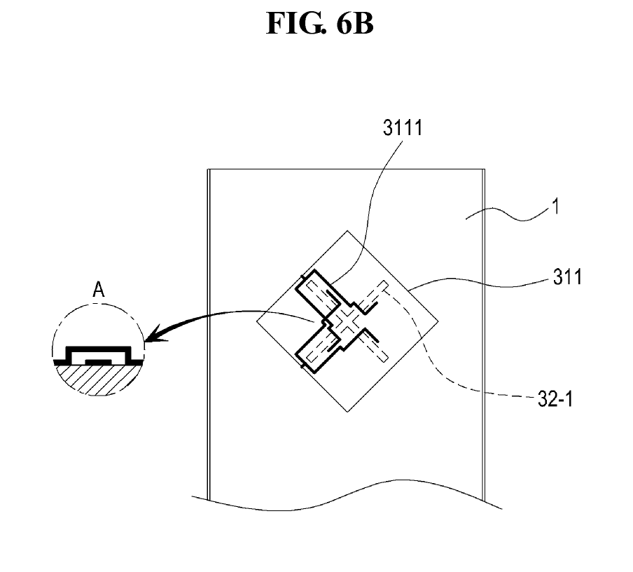

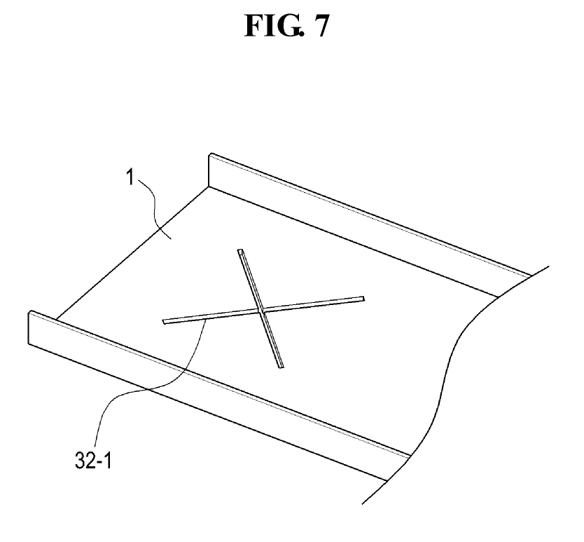

FIG. 4 is a plane view of a dual-band and dual-polarization antenna for a mobile communication base station according to an embodiment of the present disclosure, FIG. 5 is a perspective cross-sectional view cut along a portion A-A′ of FIG. 4, FIG. 6 shows a plane view and a rear view illustrating a feeding structure of a first radiant element illustrated in FIG. 4, and FIG. 7 is a perspective view of FIG. 6. In FIGS. 6 and 7, for convenience, a slot structure of first radiant elements and a circuit board where a feeding conductive pattern is formed are illustrated and other components are not illustrated.

Referring to FIGS. 4 through 7, an antenna according to an embodiment of the present disclosure has a structure in which so-called slot-type first radiant elements 31 and 32 of a first frequency band (for example, a band of 700/800 MHz) are disposed on a top surface of a reflective plate 1 at predetermined intervals. Dipole-type second radiant elements 21, 22, 23, and 24 of a second frequency band (for example, a band of 2 GHz) are stacked on the first radiant elements 31 and 32 or are directly installed on the top surface of the reflective plate 1 between the first radiant elements 31 and 32.

According to characteristics of the present disclosure, the first radiant elements 31 and 32 respectively include a slot structure 31-1 which is directly formed in the reflective plate 1 in the shape of an overall X-shaped hole to generate a transmission signal having X-shaped dual polarizations that are orthogonal to each other, and patch plates 31-1 and 32-2 made of a metallic material, such as aluminum (silver plate) or copper (silver plate), on a top surface of the slot structure 31-1. The patch plates 31-2 and 32-2 have a shape and a size that are suitable for optimization of radiation characteristics of the slot structure 31-1, and are installed using a support made of, for example, a plastic material, so as to be insulated from the lower reflective plate 1. That is, in the present disclosure, the reflective plate 1 serves as a metallic plate forming the slot structure.

The slot structure 31-1 is provided with the transmission signal by coupling with a feeding strip line (3111 of FIG. 6) that is previously formed with an appropriate conductive pattern on a circuit board 311 attached to a rear surface of the reflective plate 1. The circuit board 311 may be formed in the form of a general Printed Circuit Board (PCB).

In the X-shaped slot structure 31-1, a ‘/’-shaped slot or a ‘\-shaped slot that generates one of the X-shaped dual polarizations may be formed to have a length by considering a frequency wavelength of a first frequency band (an Advanced Wireless Service (AWS) band), for example, 2/λ. In this case, each slot may be designed to have a length of, for example, about 160 mm and a width of, for example, about 2 mm.

When the strip line 3111 that generates each of the X-shaped dual polarizations is formed on the circuit board 311, conductive patterns may be formed to be orthogonal to each other (but are not electrically connected to each other) in a portion, and as a side structure is enlarged and illustrated in a portion A in (b) of FIG. 6, one of the conductive patterns is formed to have an air bridge structure in that orthogonal portion.

Meanwhile, the second radiant elements 21 and 22 stacked on the formed first radiant elements 31 and 32 are installed on the patch plates 31-2 and 32-2 of the first radiant elements 31 and 32 and use the patch plates 31-2 and 32-2 as ground terminals. That is, the second radiant elements 21 and 22 are grounded by the patch plates 31-2 and 32-2. The second radiant elements 21 and 22 stacked on the first radiant elements 31 and 32 are connected with a feeding network through a feeding cable 212 passing through the patch plates 31-2 and 32-2 of the first radiant elements 31 and 32 and the reflective plate 1.

With the foregoing structure, in the antenna according to the present disclosure, a transmission signal applied to the feeding strip line 3111 of the circuit board 311 is coupled to the slot structure 31-1 through a dielectric layer of the circuit board 311, and thus an electric (E) field is formed in the slot structure 31-1. The E field of the transmission signal formed in the slot structure 31-1 is then radiated through the patch plates 31-2 and 32-2 that are fixed spaced apart from each other by a proper interval.

Stacked arrangement of first and second radiant elements according to the present disclosure includes only one patch plate, when compared to a conventional structure having upper and lower patch plates, such that a height difference between a second radiant element installed stacked on the first radiant element and second radiant elements installed independently is reduced. For example, a height difference of about 25 mm may exist between a second radiant element installed stacked on the first radiant element and second radiant elements installed independently. As such, since the height difference is reduced, a phase delay generated between the second radiant elements having the height difference is reduced when compared to a conventional case, and a horizontal beam-width reduction is reduced in antenna down-tilt.

Also, in this case, in the antenna according to the present disclosure, the height of the first radiant element and the height of the second radiant element installed stacked on the first radiant element are reduced when compared to a conventional case, reducing the overall height of the antenna and thus satisfying miniaturization and lightweight conditions when compared to the conventional case.

Moreover, the second radiant element installed stacked on the first radiant element uses the patch plate of the first radiant element as a ground terminal, and in the present disclosure, the patch plate of the first radiant element is formed larger than the portion of the slot structure, and thus may be designed to have a larger size than a conventional one. Therefore, the patch plate according to the present disclosure may satisfy a ground area required in the dipole-type second radiant element stacked thereon and may prevent degradation of pattern characteristics of a radio frequency in the second radiant element.

The structure and operation of the antenna for a mobile communication base station according to an embodiment of the present disclosure may be made as described above, and while detailed embodiments have been described in the description of the present disclosure, various modifications may be made without departing the scope of the present disclosure.

For example, in the foregoing description, the second radiant element installed stacked on the first radiant element is of a dipole type, but the second radiant element stacked on the first radiant element may be of a general patch type in other embodiments of the present disclosure.

Moreover, while the second radiant element is stacked on the first radiant element in the foregoing description, first radiant elements having the structure according to the present disclosure may be installed separately, without having the second radiant element stacked thereon, in other embodiments of the present disclosure.

As described above, an antenna for a mobile communication base station may reduce the entire size of the antenna, and particularly, in a dual-band antenna having a second radiant element of a second frequency band installed stacked on a first radiant element of a first frequency band and a second radiant element of the second frequency band installed independently, a height difference between the second radiant elements may be reduced, a ground area required in the second radiant element installed stacked on the first radiant element may be sufficiently secured, and radiation characteristics may be improved.

What is claimed is:

1. An antenna for a mobile communication base station, the antenna comprising:
a reflective plate; and
a first radiant element of a first frequency band, which is formed on the reflective plate,
wherein the first radiant element comprises:
a slot structure which is directly formed in the reflective plate in the form of an overall X-shaped hole to generate a transmission signal having X-shaped dual polarizations that are orthogonal to each other; and
a patch plate formed of a metallic material on a top surface of the slot structure in such a way to be insulated from the reflective plate.

2. The antenna of claim 1, further comprising a second radiant element of a second frequency band, which is installed to be stacked on the first radiant element.

3. The antenna of claim 2, wherein the second radiant element is of a dipole type and uses the patch plate of the first radiant element as a ground terminal.

4. The antenna of claim 1, wherein the slot structure of the first radiant element is connected, by coupling, with a feeding strip line formed on a circuit board attached to a rear surface of the reflective plate.
